(19) United States
(12) Patent Application Publication
(10) Pub. No.: US 2025/0045126 A1
(43) Pub. Date: Feb. 6, 2025

(54) Kernel Optimization in Radio Access Network

(71) Applicant: Rakuten Symphony, Inc., Tokyo (JP)

(72) Inventor: Volkan Sevindik, Denver, CO (US)

(21) Appl. No.: 18/646,156

(22) Filed: Apr. 25, 2024

Related U.S. Application Data
(60) Provisional application No. 63/516,685, filed on Jul. 31, 2023.

(51) Int. Cl. G06F 9/50; G06F 9/48

(52) U.S. Cl. CPC G06F 9/5083; G06F 9/4881

(57) ABSTRACT

In a cellular communication network a computing device executes applications implementing a DU or a CU. Applications have corresponding kernel optimization files that are read and used to configure parameters of a kernel, such as processor pinning, the use of real-time schedulers, and the resolution of timers. The parameters of the kernel may be selected according to the number of the applications that require real time operation to the number of those that do not. Kernel may be detected and analyzed. Kernel parameters may be relaxed in response to detected crashes.

### CROSS-REFERENCE TO RELATED APPLICATION(S)

This application claims priority to U.S. Provisional Application Ser. No. 63/516,685 filed Jul. 31, 2023 and entitled KERNEL OPTIMIZATION IN RADIO ACCESS NETWORK, which is hereby incorporated herein by reference in its entirety.

### BACKGROUND

### Field

This invention relates to kernel optimization in a radio access network.

### Background

The information disclosed in this background section is only for enhancement of understanding of the general background of the disclosure and should not be taken as an acknowledgement or any form of suggestion that this information forms the prior art already known to a person skilled in the art.

Cellular communication networks require dedicated wireless transceivers capable of sending and receiving wireless signals with respect to subscriber devices. However, the cellular communication network may also include off-the-shelf computing equipment for processing data decoded from wireless signals or to be wirelessly transmitted. Using off-the-shelf computing equipment helps reduce the cost of deploying a cellular communication network.

It would be an advancement in the art to improve the performance of computing equipment in a cellular communication network.

### SUMMARY OF THE INVENTION

A system includes one or more processing devices and a kernel executing on the one or more processing devices. A software component executes on the one or more processing devices is configured to read one or more kernel optimization files for a plurality of applications to be executed on the one or more processing devices. The software component is further configured to configure one or more parameters of the kernel according to the one or more kernel optimization files.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a cellular communication network in which kernel optimization may be performed in accordance with an embodiment;

FIG. 2 is a schematic diagram illustrating applications and corresponding kernel optimization files in accordance with an embodiment;

FIG. 3 is a process flow diagram of a method for performing kernel optimization based on kernel optimization files in accordance with an embodiment;

FIG. 4 is a process flow diagram of a method for adjusting kernel optimization in response to a crash in accordance with an embodiment; and

FIG. 5 is a schematic block diagram of an example computing device suitable for implementing methods in accordance with an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

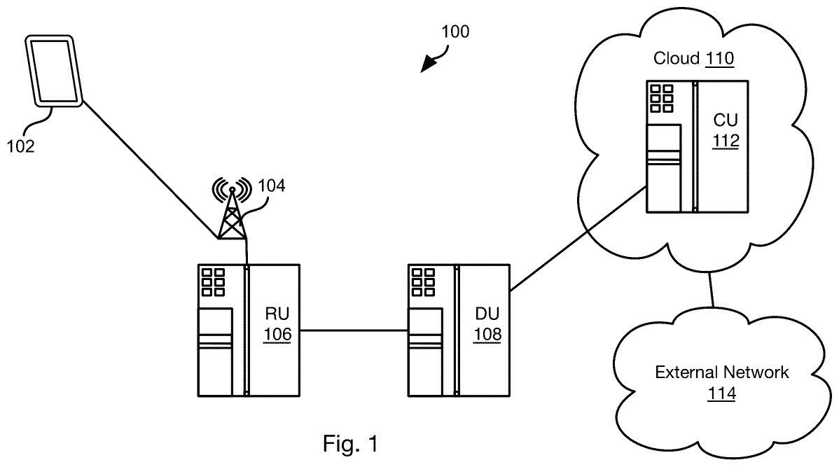

FIG. 1 illustrates an example cellular communication network 100. A subscriber device 102, such as a mobile phone or other type of device, may exchange wireless signals with a radio antenna 104. A radio unit (RU) 106 is electrically coupled to the antenna 104. The RU 106 includes specialized electronics for encoding binary data into electrical signals transmitted to the antenna 104 for wireless broadcast. The RU 106 further includes specialized electronics for decoding electrical signals received from the antenna 104 into binary data. Binary data may be sent and received by the RU 106 in the form of data packets.

Binary data decoded by the RU 106 may be transmitted to one or more distributed units (DU) 108. Likewise, binary data may be received by the RU 106 from one or more DUs 108. The DU 108 may be implemented using off-the-shelf computer equipment, such as a computing device having some or all of the attributes of the computing device 500 described below. The DU 108 may perform management tasks in order to connect subscriber devices 102 to one another in a voice telephone call. The DU 108 may route packets conveying text messages. The DU 108 may also route data packets received from or transmitted to a data network, such as the Internet, local area network (LAN), or wide area network (WAN). The DU 108 and RU 106 may together implement the 5G cellular communication standard, such as the 5G standard as defined in Technical Release (TR) 21.915, Technical Specification (TS) 22.261, TS 23.501, TS 32.240 TS 38.300 published by the Third Generation Partnership Project (3GPP), all of which are hereby incorporated herein by reference.

The DU 108 may transmit packets to and receive packets from a cloud 110 composed of multiple servers, such as the illustrated central unit (CU) 112. The CU 112 may be implemented using off-the-shelf computer equipment, such as a computing device having some or all of the attributes of the computing device 500 described below. The CU 112 may perform centralized routing of packets between DUs 108. The CU 112 may also route packets to and from an external network 114, such as the Internet.

The implementations of the RU 106, DU 108, cloud 110, and CU 112 may be according to the specifications for an O-RU, O-DU, O-Cloud, and O-CU according to the open radio area network (O-RAN) alliance standards, such as specified in the O-RAN Description 9.0 (O-RAN.WG1.OAD-R003-v09.00), published June 2023, which is hereby incorporated herein by reference in its entirety.

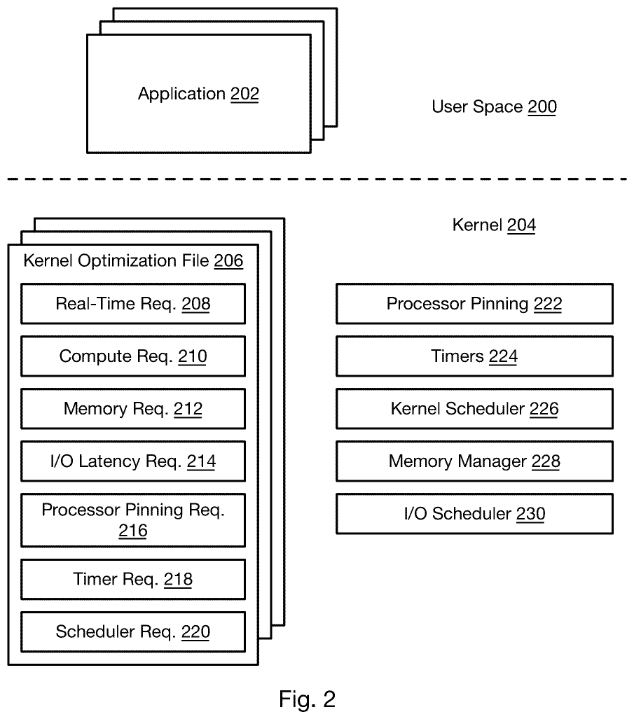

Referring to FIG. 2, a DU 108 and/or CU 112 may be implemented as illustrated. Specifically, an operating system such as LINUX, WINDOWS, MACOS, or the like may define a user space 200 in which user applications 202 execute. The operating system may further include a kernel 204 including variables and functions for interfacing with components of a computing device, such as the computing device 500 described below. The kernel 204 may also be part of container, virtual machine, or other execution context executing one or more applications 202.

In a cellular communication network 100, the functions described above as being performed on the DU 108 and/or CU 112 may be implemented by applications 202 executing on the DU 108 and/or CU 112. Many of such applications 202 are “real-time” applications. A real-time application may be defined as one in which processing of events (e.g., received packets, commands from another application or component, a condition being satisfied, an interrupt being received, etc.) to be near instantaneous, i.e., without waiting for another application to finish processing. A real-time application may be defined in terms of a maximum permitted delay between receiving an event and when processing of the event begins, such as less than 2 milliseconds, less than 1 millisecond, or less than 0.5 milliseconds, or some other value. A real-time application may be defined as one that cannot be preempted by another application or process of the operating system on the computing device executing the real-time application. A real-time application may be as defined in the O-RAN WG6 Cloud REF v02, which is hereby incorporated herein by reference.

In order to implement real-time applications, O-RAN WG6 Cloud REF v02 recommends using real-time preemption patches for workloads implemented on DUs 108 and CUs 112. Using the approach described herein, a kernel 204 may be further adapted to execute real-time applications in order to improve stability and increase the probability of meeting latency requirements of a real-time application.

In the illustrated embodiment, a kernel optimization file 206 is provided for each application 202, or only for each real-time application 202, whose execution is facilitated by the kernel 204. Multiple applications 202 may be configured according to a same kernel optimization file 206. The kernel optimization file 206 may be human generated for each application 202. Alternatively, the kernel optimization file 206 may be selected automatically based on a role, type, or other attribute of an application 202. The kernel optimization file 206 may be automatically generated for an application 202 based on parameters specified in a configuration file, executable, environmental variables, or other data associated with an application 202.

The kernel optimization file 206 for an application 202 may include a real-time requirement 208, e.g., a flag, variable, or other data in the kernel optimization file 206 indicating whether the application 202 is a real-time application. The real-time requirement 208 may include a required latency value such that required latency values below a threshold indicate a real-time requirement.

The kernel optimization file 206 may additionally or alternatively include other requirements, such as a compute requirement 210 (e.g., number of processors or processor cores required to allocated to or otherwise used by the application 202), a memory requirement 212 (e.g., amount of memory required to be allocated to or otherwise used by the application 202), an I/O latency requirement 214 (e.g., a maximum permissible latency for I/O operations such as reads and writes to volatile memory and/or persistent storage).

The kernel optimization file 206 may additionally or alternatively include a processor pinning requirement 216, a timer requirement 218, and a scheduler requirement 220. The processor pinning requirement 216 indicates whether, and possibly how many, processor cores should be pinned to the application 202, i.e. allocated for the exclusive use of the application 202. The timer requirement 218 indicates the resolution of timers used to evaluate when to perform time-dependent tasks of the application 202, such as when to check for interrupts, whether a condition has been satisfied, whether a packet has been received or is ready for transmission, or other events. In general, the higher the resolution (smaller the time increments) of the timer, the closer the application performance 202 will approximate real-time responsiveness. The scheduler requirement 220 may specify a type of scheduler to be used by the kernel 204 to schedule performance of tasks of the application 202. For example, the value for the scheduler requirement 220 may be selected from values such as a real-time scheduler, a real-time scheduler exclusive to the application 202, or a non-real-time scheduler. A real-time scheduler may be a real-time kernel process within the definition of “real-time” outlined above. The real-time scheduler may have higher priority than other schedulers with interrupts of the scheduler given higher priority and not being preemptable by other interrupts, applications, or other kernel processes.

As described in greater detail below, some or all of the entries in the kernel optimization file 206 may be modified in order to improve stability and/or performance of the kernel 204.

The kernel 204 may ingest the kernel optimization files 206 and adjust one or more internal parameters, data structures, and/or processes of the kernel 204. For example, the kernel 204 may create and/or configure one or more processor pinnings 222, timers 224, and/or kernel schedulers 226 according to the processor pinning requirements 216, timer requirements 218, and/or scheduler requirements 220, respectively, of the one or more kernel optimization files 206.

The kernel 204 may further modify one or both of the memory manager 228 and I/O scheduler 230 according to the memory requirement 212 and I/O latency requirement 214 of the kernel optimization files 206.

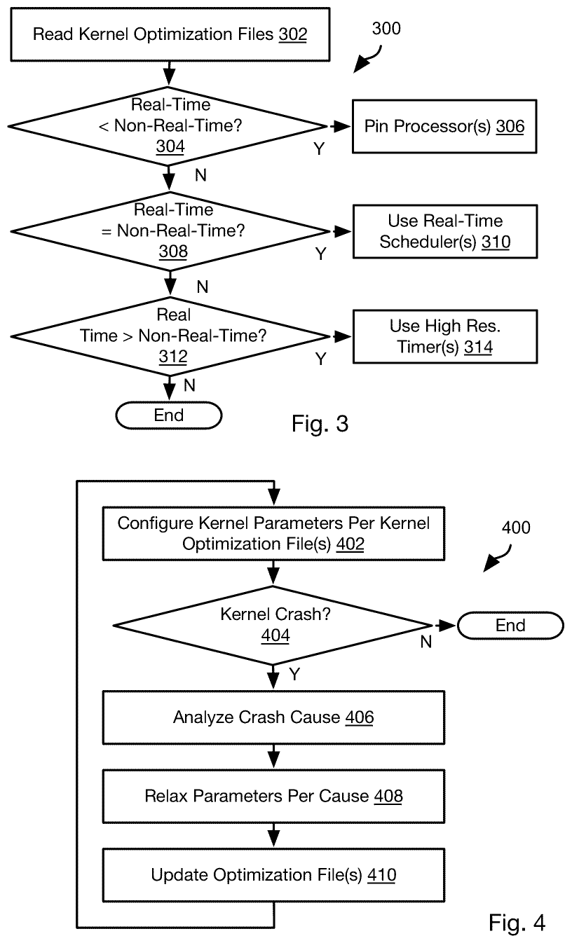

FIG. 3 illustrates a method 300 that may be performed by a software component executing in the kernel 204 or a process external to the kernel 204, to configure the kernel 204 according to one or more kernel optimization files 206. The method 300 includes reading 302 the kernel optimization files 206 and evaluating how many of the kernel optimization files 206 include a real-time requirement and how many do not have a real-time requirement. The real-time requirement may be determined from the real-time requirements 208 in the kernel optimization files 206 indicating that the application 202 is a real-time application. The number of non-real-time applications 202 may be determined by the kernel 204 or other process executing the method 300 based on one or both of (a) a number of kernel optimization files 206 including real-time requirements 208 indicating that real-time operation is not required and (b) a number of applications 202 lacking a kernel optimization file 206.

If the number of real-time applications 202 is found 304 to be less than the number of non-real-time applications 202, the method 300 may include pinning 306 one or more processors to the real-time applications 202. Step 306 may include pinning one processor (e.g., processor core of one or more multi-core processors) exclusively to each real-time application 202. In some embodiments, multiple real-time applications 202 may be pinned to the same processor core.

If the number of real-time applications 202 is found 308 to be equal to the number of non-real-time applications 202, the method 300 may include using 310 real-time kernel schedulers 226. Step 310 may include configuring the kernel 204 to use one or more real-time kernel schedulers 226 to schedule tasks for the real-time applications 202. In some embodiments, a single real-time kernel scheduler 226 is used to schedule execution of all of the real-time applications 202. In other embodiments, a separate real-time kernel scheduler 226 is configured for each real-time application 202. The kernel 204 may be configured at step 310 to use one or more non-real-time kernel schedulers 226 for scheduling execution of the non-real-time applications 202.

If the number of real-time applications 202 is found 312 to be greater than the number of non-real-time applications 202, the method 300 may include using 314 one or more high-resolution timers 224 for the real-time applications 202. Step 314 may include configuring the kernel 204 to implement a separate high-resolution timer 224 for each real-time application 202. Alternatively, step 314 may include configuring a single high-resolution timer 224 for use by multiple real-time applications. Step 314 may include configuring the kernel 204 to use one or more lower resolution timers 224 for the non-real-time applications 202. As used herein, “high-resolution timers” may be understood as meaning having a time increment at which time is measured that is smaller than that of the low-resolution timers, e.g., at least 2, 4, 8, or 16 times smaller than that of a low-resolution timer. A “high-resolution timer” may be understood as measuring time in increments that are smaller than the duration of 10, 5, 3, or 2 processor cycles of any of the processors executing the kernel 204.

If none of the conditions of steps 304, 308, 312 are found to be met, the method 300 may end. In some embodiments, the method 300 may include implementing other requirements of the kernel optimization files 206, such as some or all of the compute requirement 210, memory requirement 212, and I/O latency requirement 214.

The method 300 is exemplary only. Various combinations of processor pinning, use of real time schedulers, and use of high resolution timers may be implemented for various possible values for the number of real-time applications and the number of non-real-time applications

Referring to FIG. 4, in some scenarios, implementing all of the requirements of the kernel optimization files 206 may cause kernel instability. Accordingly, a software component executing in the kernel 204 or a process external to the kernel 204 may execute the method 400 in order to adjust the kernel optimization files 206 and/or the implementation thereof in order to promote stability of the kernel 204.

The method 400 may include configuring 402 kernel parameters according to the kernel optimization files 206. Step 402 may include performing the method 300 as described above. For a first iteration of the method 400, the kernel optimization files 206 are as specified by a human or automatically generated for each application 202 as described above.

The applications 202 may then commence execution on the processing devices executing the kernel 204 subject to control of the kernel 204 as configured at step 402. The method 400 may include evaluating 404 whether executing the applications 202 has caused the kernel 204 to crash. For example, the kernel 204 may include a crash handler. Step 404 may therefore include querying the crash handler to determine whether a crash has occurred.

If so, the method 400 may include analyzing 406 a cause of the crash. For example, step 406 may include obtaining, from the crash handler, a location in memory where crash information is stored. The crash information may then be analyzed 460 to determine a cause of the crash. For example, analyzing 406 the cause of the crash may include using the approach described in U.S. Pat. No. 8,776,026, which is hereby incorporated herein by reference.

The method 400 may include relaxing 408 one or more parameters of the kernel based on the cause of the crash. The parameters may include some or all of the processor pinning 222, the configuration of the timers 224 (e.g., high and low resolution timers), the configuration of kernel schedulers 226 (e.g., real-time and non-real-time schedulers), the configuration of the memory manager 228, and the configuration of the I/O scheduler 230.

For example, where a cause of the crash is found to be one of the real-time applications 202, relaxing 408 the parameters of the kernel may include relaxing some or all of processor pinning, the use of real-time schedulers, and/or the use of high resolution timers. For example, relaxing may replace a requirement for processor pinning (see step 306 described above) with the use of a real-time scheduler (see step 310 described above). Relaxing may include replacing a requirement for the use of a real-time scheduler with the use of one or more high-resolution timers (see step 314 described above). Relaxing may include removing a requirement for the use of a one or more high-resolution timers. Relaxing 408 may proceed in a sequence with each crash resulting in further relaxation of parameters: pinning to use of a real-time scheduler, use of a real-time scheduler to use of high resolution timers, use of high-resolution timers to no requirements for the use of high-resolution timers.

The method 400 may include updating the kernel optimization files 206 according to the relaxing of step 408. Accordingly, the kernel optimization files 206 will specify a processor pinning requirement 216, timer requirement 218, and/or scheduler requirement 220 for each real-time application 202 as determined during the relaxing step 408. The method 400 may then repeat at step 402 with the parameters of the kernel being configured according to the kernel optimization files as updated at step 410.

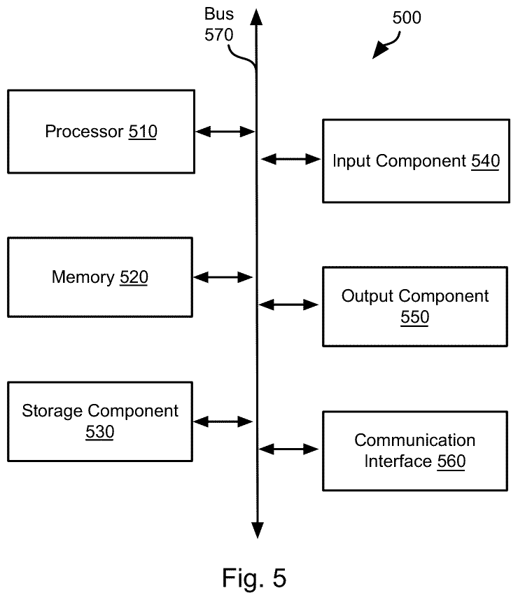

FIG. 5 illustrates an embodiment of a device 500. As shown in FIG. 5, the device 500 processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU) a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, instructions to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

In a first example embodiment, a system includes one or more processing devices; a kernel executing on the one or more processing devices; and a software component executing on the one or more processing devices is configured to: read one or more kernel optimization files for a plurality of applications to be executed on the one or more processing devices; and configure one or more parameters of the kernel according to the one or more kernel optimization files.

In a second example embodiment of the system according to any of the example embodiments, the plurality of applications implement part of a cellular telecommunication system.

In a third example embodiment of the system according to any of the example embodiments, the plurality of applications implement part of an Open Radio Area Network (O-RAN) telecommunication system.

In a fourth example embodiment of the system according to any of the example embodiments, the plurality of applications implement a distributed unit (DU) or centralized unit (CU) of an Open Radio Area Network (O-RAN) telecommunication system.

In a fifth example embodiment of the system according to any of the example embodiments, the one or more parameters include at least one of processor pinning, scheduler configuration, or timer resolution.

In a sixth example embodiment of the system according to any of the example embodiments, the software component is further configured to configure the one or more parameters of the kernel according to a number of real-time applications among the plurality of applications as indicated in the one or more kernel optimization files.

In a seventh example embodiment of the system according to any of the example embodiments, the software component is further configured to configure the one or more parameters of the kernel according to a number of non-real-time applications among the plurality of applications as indicated in the one or more kernel optimization files. In an eighth example embodiment of the system according to any of the example embodiments, the software component is further configured to pin the real-time applications to the one or more processing devices if the number of real-time applications is less than the number of non-real-time applications.

In a ninth example embodiment of the system according to any of the example embodiments, the software component is further configured to implement one or more real-time schedulers for managing execution of the real-time applications if the number of real-time applications is equal to the number of non-real-time applications.

In a tenth example embodiment of the system according to any of the example embodiments, the software component is further configured to increase a resolution of timers of the kernel if the number of real-time applications is greater than the number of non-real-time applications.

In an eleventh example embodiment of the system according to any of the example embodiments, the software component is further configured to: detect a crash of the kernel following execution of the plurality of applications; evaluate a cause of the crash; and relax the one or more parameters according to the cause of the crash.

In a twelfth example embodiment of the system according to any of the example embodiments, the software component is configured to relax the one or more parameters according to the cause of the crash by: changing a requirement for pinning of one or more real-time applications of the plurality of applications to a processor of the one or more processing devices to a requirement for use of a real-time scheduler for the one or more real-time applications.

In a thirteenth example embodiment of the system according to any of the example embodiments, the software component is configured to relax the one or more parameters according to the cause of the crash by: changing a requirement for use of a real-time scheduler for one or more real-time applications of the plurality of applications to a requirement for increased resolution of a timer used to manage execution of the one or more real-time applications.

In a fourteenth example embodiment of the system according to any of the example embodiments, the software component is configured to relax the one or more parameters according to the cause of the crash by: removing a requirement for use of increased resolution of a timer used to manage execution of one or more real-time applications of the plurality of applications.

In a fifteenth example embodiment, a method includes processing, by a software component executing on one or more processing devices, one or more kernel optimization files for a plurality of applications; configuring, by the software component, one or more parameters of a kernel executing on the one or more processing devices according to the one or more kernel optimization files; and executing the plurality of applications by the kernel according to the one or more parameters.

In a sixteenth example embodiment of the method according to any of the example embodiments, the plurality of applications implement a distributed unit (DU) or centralized unit (CU) of an Open Radio Area Network (O-RAN) telecommunication system.

In a seventeenth example embodiment of the method according to any of the example embodiments, the method further includes configuring, by the software component, the kernel to pin real-time applications of the plurality of applications to the one or more processing devices in response to a number of the real-time applications being less than a number of non-real-time applications of the plurality of applications indicated by the one or more kernel optimization files.

In an eighteenth example embodiment of the method according to any of the example embodiments, the method further includes configuring, by the software component, the kernel to implement one or more real-time schedulers for managing execution of real-time applications of the plurality of applications in response to a number of the real-time applications being equal to a number of non-real-time applications of the plurality of applications indicated by the one or more kernel optimization files.

In a nineteenth example embodiment of the method according to any of the example embodiments, the method further includes increasing, by the software component, resolution of timers of the kernel for use with real-time applications of the plurality of applications in response to a number of the real-time applications being greater than a number of non-real-time applications of the plurality of applications indicated by the one or more kernel optimization files.

In a twentieth example embodiment of the method according to any of the example embodiments, the method further includes detecting, by the software component, a crash of the kernel following execution of the plurality of applications; evaluating, by the software component, a cause of the crash; and relaxing, by the software component, the one or more parameters according to the cause of the crash

1. A system comprising:
one or more processing devices;
a kernel executing on the one or more processing devices; and
a software component executing on the one or more processing devices is configured to:
read one or more kernel optimization files for a plurality of applications to be executed on the one or more processing devices; and
configure one or more parameters of the kernel according to the one or more kernel optimization files.

2. The system of claim 1, wherein the plurality of applications implement part of a cellular telecommunication system.

3. The system of claim 1, wherein the plurality of applications implement part of an Open Radio Area Network (O-RAN) telecommunication system.

4. The system of claim 1, wherein the plurality of applications implement a distributed unit (DU) or centralized unit (CU) of an Open Radio Area Network (O-RAN) telecommunication system.

5. The system of claim 1, wherein the one or more parameters include at least one of processor pinning, scheduler configuration, or timer resolution.

6. The system of claim 1, wherein the software component is further configured to configure the one or more parameters of the kernel according to a number of real-time applications among the plurality of applications as indicated in the one or more kernel optimization files.

7. The system of claim 6, wherein the software component is further configured to configure the one or more parameters of the kernel according to a number of non-real-time applications among the plurality of applications as indicated in the one or more kernel optimization files.

8. The system of claim 7, wherein the software component is further configured to pin the real-time applications to the one or more processing devices if the number of real-time applications is less than the number of non-real-time applications.

9. The system of claim 7, wherein the software component is further configured to implement one or more real-time schedulers for managing execution of the real-time applications if the number of real-time applications is equal to the number of non-real-time applications.

10. The system of claim 7, wherein the software component is further configured to reduce increase a resolution of timers of the kernel if the number of real-time applications is greater than the number of non-real-time applications.

11. The system of claim 1, wherein the software component is further configured to:
detect a crash of the kernel following execution of the plurality of applications;
evaluate a cause of the crash; and
relax the one or more parameters according to the cause of the crash.

12. The system of claim 11, wherein the software component is configured to relax the one or more parameters according to the cause of the crash by:
changing a requirement for pinning of one or more real-time applications of the plurality of applications to a processor of the one or more processing devices to a requirement for use of a real-time scheduler for the one or more real-time applications.

13. The system of claim 11, wherein the software component is configured to relax the one or more parameters according to the cause of the crash by:
changing a requirement for use of a real-time scheduler for one or more real-time applications of the plurality of applications to a requirement for increased resolution of a timer used to manage execution of the one or more real-time applications.

14. The system of claim 11, wherein the software component is configured to relax the one or more parameters according to the cause of the crash by:
removing a requirement for use of increased resolution of a timer used to manage execution of one or more real-time applications of the plurality of applications.

15. A method comprising:
processing, by a software component executing on one or more processing devices, one or more kernel optimization files for a plurality of applications;
configuring, by the software component, one or more parameters of a kernel executing on the one or more processing devices according to the one or more kernel optimization files; and
executing the plurality of applications by the kernel according to the one or more parameters.

16. The method of claim 15, further comprising configuring, by the software component, the kernel to pin real-time applications of the plurality of applications to the one or more processing devices in response to a number of the real-time applications being less than a number of non-real-time applications of the plurality of applications indicated by the one or more kernel optimization files.

17. The method of claim 15, further comprising configuring, by the software component, the kernel to implement one or more real-time schedulers for managing execution of real-time applications of the plurality of applications in response to a number of the real-time applications being equal to a number of non-real-time applications of the plurality of applications indicated by the one or more kernel optimization files.

18. The method of claim 15, further comprising increasing, by the software component, resolution of timers of the kernel for use with real-time applications of the plurality of applications in response to a number of the real-time applications being greater than a number of non-real-time applications of the plurality of applications indicated by the one or more kernel optimization files.

19. The method of claim 15, further comprising:
detecting, by the software component, a crash of the kernel following execution of the plurality of applications;
evaluating, by the software component, a cause of the crash; and
relaxing, by the software component, the one or more parameters according to the cause of the crash.

20. A non-transitory computer-readable medium storing executable code that, when executed by one or more processing devices, causes the one or more processing devices to:
read one or more kernel optimization files for a plurality of applications to be executed on the one or more processing devices; and
configure one or more parameters of a kernel executing on the one or more processing devices according to the one or more kernel optimization files.
